(19) United States
(12) Patent Application Publication
(10) Pub. No.: US 2005/0129131 A1
(43) Pub. Date: Jun. 16, 2005

(54) MEMORY STORAGE METHOD FOR IMPROVING EFFICIENCY OF IMAGE PROCESSING

(76) Inventors: Yi-Shu Chang, Hsin-Chu Hsien (TW); Chao-Chih Huang, Tai-Chung Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/904,777

(22) Filed: Nov. 29, 2004

(30) Foreign Application Priority Data
Dec. 11, 2003 (TW) 092135019

(51) Int. Cl. H04N 7/12

(52) U.S. Cl. 375/240.24; 375/240.12

(57) ABSTRACT

A memory storage method for improving efficiency of image processing. The method includes: storing a plurality of first blocks corresponding to a first picture region of a picture into a first storage region of a memory, storing a plurality of second blocks corresponding to a second picture region of the picture into a second storage region of the memory, and storing at least one second block corresponding to a part of the second picture region adjacent to the first picture region into the first storage region.

### BACKGROUND OF INVENTION

1. Field of the Invention

The invention relates to memory, and more particularly, to a memory storage method for improving efficiency of image processing.

2. Description of the Prior Art

Along with the improvement of the operating speed of digital circuitry, the video/audio processing requiring huge amount of operations has become a crucial issue nowadays while users require higher image resolution. Regarding a high-definition television (HDTV) specification, the resolution (of the picture) typically may contain 1920(horizontal)*1088(vertical) pixels in one frame. In addition, during image processing related to the MPEG (Moving Picture Experts Group) specification or the procedure requiring motion compensation operation, various accesses towards block-based images of different motion vectors in a memory, such as a DRAM (Dynamic Random access Memory), are required. However, when the width of a picture stored in a row of the memory is less than the width of a high-resolution picture (HDTV specification), a crossing-row reading operation toward the memory becomes inevitable during the above-mentioned image processing to acquire the desired motion vector. For instance, each row in a DRAM includes 256 words corresponding to a width of 1024 pixels in the picture, and thus the related MPEG operation under a 1920*1088-pixel resolution will lead to a crossing-row reading operation. Any delay in the (RAS/CAS) control signal caused by the crossing-row reading operation tends to reduce the efficiency of the image processing.

### SUMMARY OF INVENTION

It is therefore one of the many objectives of the claimed invention to provide a memory storage method for improving efficiency of image processing.

According to the claimed invention, a memory storage method for improving efficiency of image processing includes storing a plurality of first blocks corresponding to a first picture region of a picture into a first storage region of a memory, storing a plurality of second blocks corresponding to a second picture region of the picture into a second storage region of the memory, and storing at least one second block corresponding to a part of the second picture region adjacent to the first picture region into the first storage region.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a flow chart showing a memory storage method for improving the efficiency of the image processing according to an embodiment of the present invention.

FIG. 2 is a schematic diagram of a portion of a picture.

FIG. 3 is a schematic diagram of a storage region.

### DETAILED DESCRIPTION

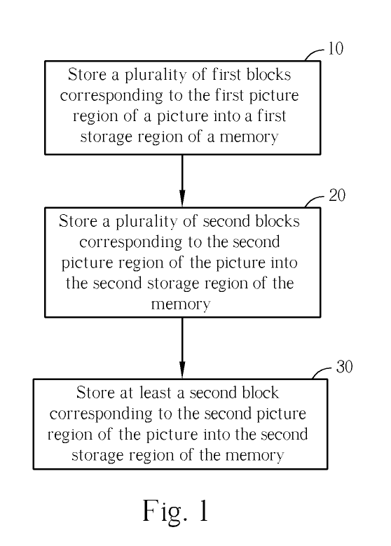

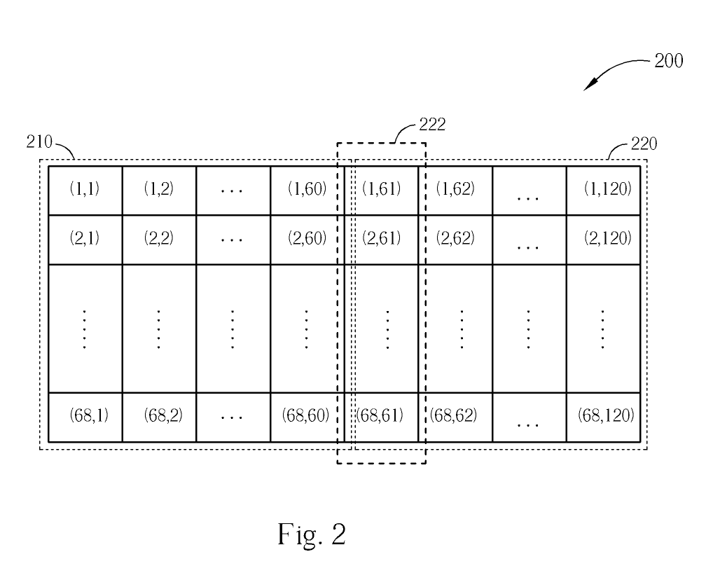

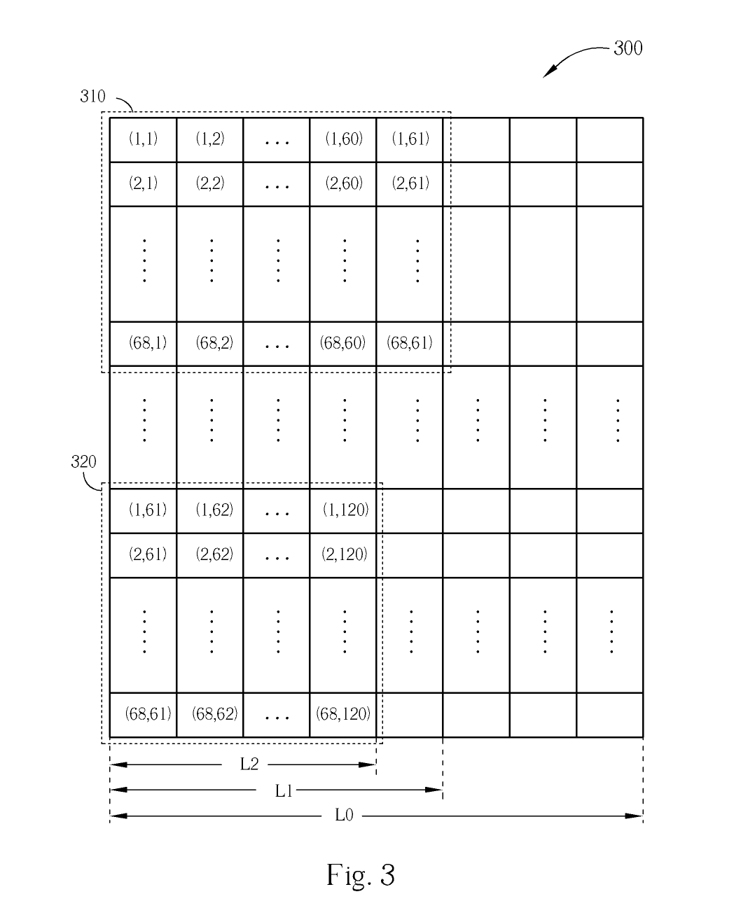

Please refer to FIG. 1, FIG. 2, and FIG. 3. FIG. 1 is a flow chart showing the memory storage method for improving the efficiency of the image processing according to an embodiment of the present invention, FIG. 2 is a schematic diagram of a portion of a picture, and FIG. 3 is a schematic diagram of storage regions of a memory, wherein FIG. 2 and FIG. 3 are illustrated in an attempt of assisting the explanation of the method in FIG. 1. Please note that the order of the following steps is not meant to serve as limitation of the invention. The memory storage method includes:
Step 10: Store a plurality of first blocks (1,1), (1,2), . . . , (68,60) corresponding to the first picture region 210 of a picture 200 into a first storage region 310 of a memory 300, which, in the present embodiment, is implemented with a DRAM, while not limited thereto;
Step 20: store a plurality of second blocks (1,61), (1,62), . . . , (68,120) corresponding to the second picture region 220 of the picture 200 into a second storage region 320 of the memory 300; and
Step 30: store at least one second block (1,61), (2,61), . . . , (68,61) corresponding to the portion 222 of the second picture region 220, wherein such portion 222 is adjacent to the first picture region 210, into the first storage region 310.

In the present embodiment, the plurality of blocks (1,1), (1,2), . . . , (68,120) shown in FIG. 2 and FIG. 3 are macroblocks conforming to the MPEG (Moving Picture Experts Group) specification, wherein each block corresponds to 16(horizontal)*16(vertical) pixels in the picture 200. The picture 200 of the present embodiment can be a picture of the HDTV (High-Definition Television), and its resolution is 1920 (horizontal)*1088(vertical) pixels. Therefore, the picture 200 includes 120(horizontal)*68(vertical) blocks. The sequence of the first blocks (1,1), (1,2), . . . , (68,60) and the second blocks (1,61), (2,61), . . . , (68,61) being stored in the first storage region 310 corresponds to the sequence of the blocks (1,1), (1,2), . . . , (68,61) being arranged in the picture 200. In addition, the sequence of the second blocks (1,61), (1,62), . . . , (68,120) being stored in the second storage region 320 corresponds to the sequence of the blocks (1,61), (1,62), . . . , (68,120) being arranged the picture 200.

In the present embodiment, the width of the picture 200, or 120 blocks corresponding to 1920 pixels, is greater than the width L0 of each row of the memory 300, or 64 blocks corresponding to 1024 pixels. The width L1 of the first storage region 310 (61 blocks corresponding to 976 pixels) and the width L2 of the second storage region 320 (60 blocks corresponding to 960 pixels) are both less than or equal to the width L0 of each row of the memory 300. As shown in FIG. 3 and FIG. 2, the width L1 of the first storage region 310 is equal to the width of the first picture region 210 (60 blocks corresponding to 960 pixels) added with the width (corresponding to 16 pixels) of a block, which is the width of the block (1,61), (2,61), . . . , or (68,61).

In image processing techniques such as, but not limited to, motion estimation or motion compensation, it is common to have pixel data read from a memory, such as a DRAM, in blocks. In order to maximize the effectiveness of the method depicted above in the embodiment of the invention, the width of duplication (i.e., the number of columns of pixels) of the second storage region in the first storage region is preferrably designated the width of the block of the underlying block-read process, as shown in the earlier embodiment by a duplication of one macroblock wide, or 16 pixels wide. However, as should be understood by those of ordinary skill in the art, the width of duplication may also be designated larger or smaller than the block width of the block-read process without altering the merits of the invention. Furthermore, as a person of ordinary skill in the art should also be able to appreciate, the concept of “block” herein can range from a 1×1 block, i.e., a single pixel, to a block composed of multiple pixels with any given height and any given width, and should not be limited to a narrowly construed 8×8 or 16×16 “macroblock”.

One of the advantages of the present invention is that no crossing-row reading operation towards the memory is needed and the motion vector for motion compensation operation can be acquired when the width of the picture corresponding to a row of the memory is less than the width of a high-resolution picture. Therefore, the method depicted in the embodiment of the present invention can improve the efficiency of the image processing.

Those skilled in the art will readily observe that numerous modifications and alterations of the device and method may be made while retaining the teachings of the invention. Accordingly, the above disclosure should be construed as limited only by the metes and bounds of the appended claims.

1. A memory storage method for improving efficiency of image processing, the memory storage method comprising:
storing a plurality of first blocks corresponding to a first picture region of a picture into a first storage region of a memory;
storing a plurality of second blocks corresponding to a second picture region of the picture into a second storage region of the memory; and
storing at least one second block corresponding to a part of the second picture region adjacent to the first picture region into the first storage region.

2. The memory storage method of claim 1 wherein the memory is a dynamic random access memory (DRAM).

3. The memory storage method of claim 1 wherein the plurality of blocks are macroblocks.

4. The memory storage method of claim 1 wherein the plurality of blocks conform to the MPEG specification.

5. The memory storage method of claim 1 wherein the width of the first storage region is equal to the width of the first picture region added to the width of a block of the plurality of blocks.

6. The memory storage method of claim 1 wherein a sequence related to the first block and the second block stored in the first storage region corresponds to a sequence among blocks of the picture.

7. The memory storage method of claim 1 wherein a sequence related to the second block stored in the second storage region corresponds to a sequence among blocks of the picture.

8. The memory storage method of claim 1 wherein the widths of the first storage region and the second storage region are less than or equal to the width of each row of the memory.

9. The memory storage method of claim 1 wherein the width of the picture is greater than that of each row of the memory.

10. The memory storage method of claim 1 wherein the picture is an HDTV picture.

11. A method for storing image data, comprising:
storing a first portion of a plurality of pixel data of the image data into a first storage region of a memory;
storing a second portion of the plurality of pixel data of the image data into a second storage region of the memory; and
storing a part of the second portion of the plurality of pixel data into the first storage region of the memory.

12. The method of claim 11, wherein the first portion of the plurality of pixel data and the second portion of the plurality of pixel data are sequentially allocated in the image data.

13. The method of claim 11, wherein the part of the second portion of the plurality of pixel data comprises pixel data of the second portion, which are adjacent to the first portion of the plurality of pixel data.
